(19) United States
(12) Patent Application Publication
(10) Pub. No.: US 2007/0247804 A1
(43) Pub. Date: Oct. 25, 2007

(54) High-density disk array device

(76) Inventors: Xiang Li, Shanghai (CN); Xiao-Xuan Chen, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/408,038

(22) Filed: Apr. 21, 2006

(51) Int. Cl. G06F 1/20; G06F 1/16

(52) U.S. Cl. 361/687; 361/685

(57) ABSTRACT

A high-density disk array device can enhance accessing capacity and heat-dissipating capacity, which includes a casing formed with an entry. A pair of disk modules and a pair of fan modules are received in the casing. The pair of disk modules can be drawn from the entry of the casing. Each of the disk modules has a plurality of hard disks received therein in a drawable way, a power module and an input/output module. The pair of fan modules are arranged adjacent to an outer side of the pair of disk modules correspondingly. A central passageway is formed between the pair of disk modules. After the disk module is drawn out from the casing, the hard disks can be drawn along a direction perpendicular to the central passageway.

### BACKGROUND OF THE INVENTION

1. Field of the Invention

The present invention relates to a high-density disk array device, and in particular to a disk array device can accommodate a plurality of hard disks therein in a high density way.

2. Description of Related Art

A disk array device for use as an external storage device in a computer system (such as a server) generally comprises hard disk drives, a controller, a power supply, a battery, an enclosure, and a fan. These components are placed within a single housing.

In order to prevent the housing internal temperature from rising and effecting the operation of computer system, the fan takes in air from the outside of the housing to forcibly replace internal air with external air.

It is highly requested that such a disk array device be downsized. However, the size of the disk array device generally increases with an increase in its storage capacity. This is because, since the use of a larger number of hard disk drives and a higher-performance controller is required to provide a large storage capacity, a large-size power supply and a cooling device have to be provided. To provide adequate cooling performance, it is also necessary to consider the device's internal ventilation. When a plurality of disk array devices of a greater size is added for use, the required installation area increases accordingly.

For fulfilling the aforementioned details, there is a prior art of disk array device of U.S. Pat. No. 6,950,304, which is published on Sep. 27, 2005. However, the space arrangement of hard disks in the prior art still lacks effectiveness. Besides, it only has two fan modules, and takes in air from one single side of the casings.

Accordingly, the present invention aims to propose a disk array device that solves the above-mentioned problems in the prior art.

### SUMMARY OF THE INVENTION

An object of the present invention is to provide a high-density disk array device, which can accommodate a plurality of hard disks in a high-density way for increasing the capacity of IOPS (I/O operations per second) per volume of the disk array device.

Another object of the present invention is to provide a high-density disk array device, which can provide good heat-dissipating effectiveness for the hard disks in high-density arrangement, for ensuring the operation stability of the disk array device.

To achieve the object described above, the present invention provides a high-density disk array device, which comprises a casing, and a pair of disk modules. The casing has an entry formed at a front surface thereof. The pair of disk modules are received in the casing and are drawable outwardly from the entry of the casing. Each of the disk modules has a plurality of hard disks received therein in a drawable way, at least one power module, and at least one input/output module. The power module and the input/output module are adjacent to a rear surface of the casing and electrically connecting to the hard disks. A central passageway is formed between the pair of disk modules. When the disk module is drawn outside from the casing, the hard disks are drawable along a direction perpendicular to the central passageway.

To achieve the object described above, the high-density disk array device of the present invention further comprising a pair of fan modules received in the casing and adjacent to an outer side of the pair of disk modules correspondingly.

The high-density disk array device of the present invention can accommodate hard disks in high-density arrangement, and enhance the capacity of IOPS (I/O operations per second) per volume of the disk array device. In addition, it provides good heat-dissipating effectiveness for the hard disks for ensuring the operation stability of the disk array device.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention can be fully understood from the following detailed description and preferred embodiment with reference to the accompanying drawings, in which:

FIG. 1 is a perspective view of a high-density disk array device according to the present invention;

FIG. 2 is a perspective view of a high-density disk array device with a disk module in a drawn-out condition according to the present invention;

FIG. 3 is a perspective view of a high-density disk array device with a hard disk in a drawn-out condition according to the present invention;

FIG. 4 is a perspective view of a high-density disk array device with heat-dissipating airflow according to the present invention; and

FIG. 5 is a perspective view of a high-density disk array device being assembled in a cabinet according to the present invention.

### DETAILED DESCRIPTION OF THE PREFERRED EMBODIMENTS

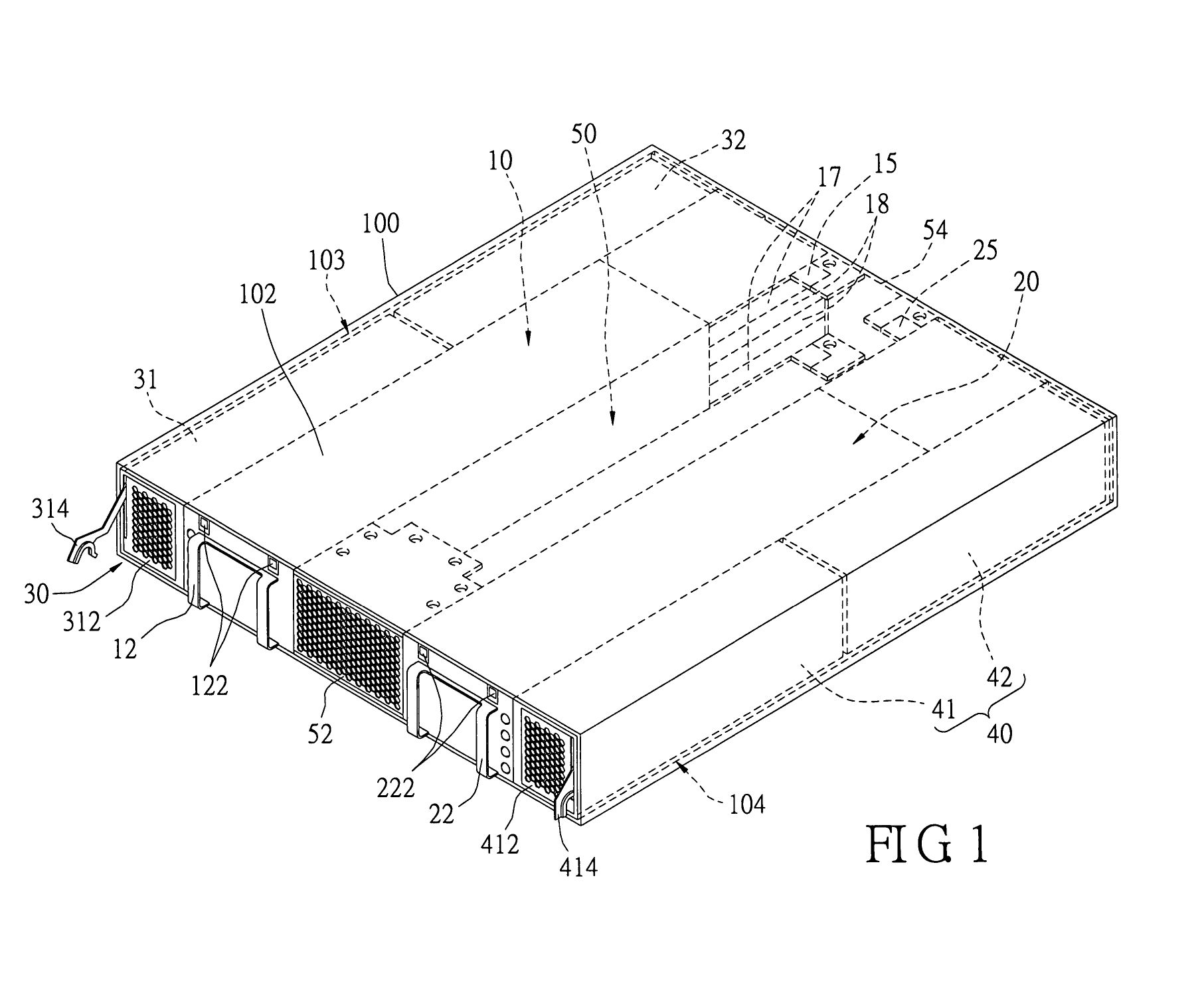

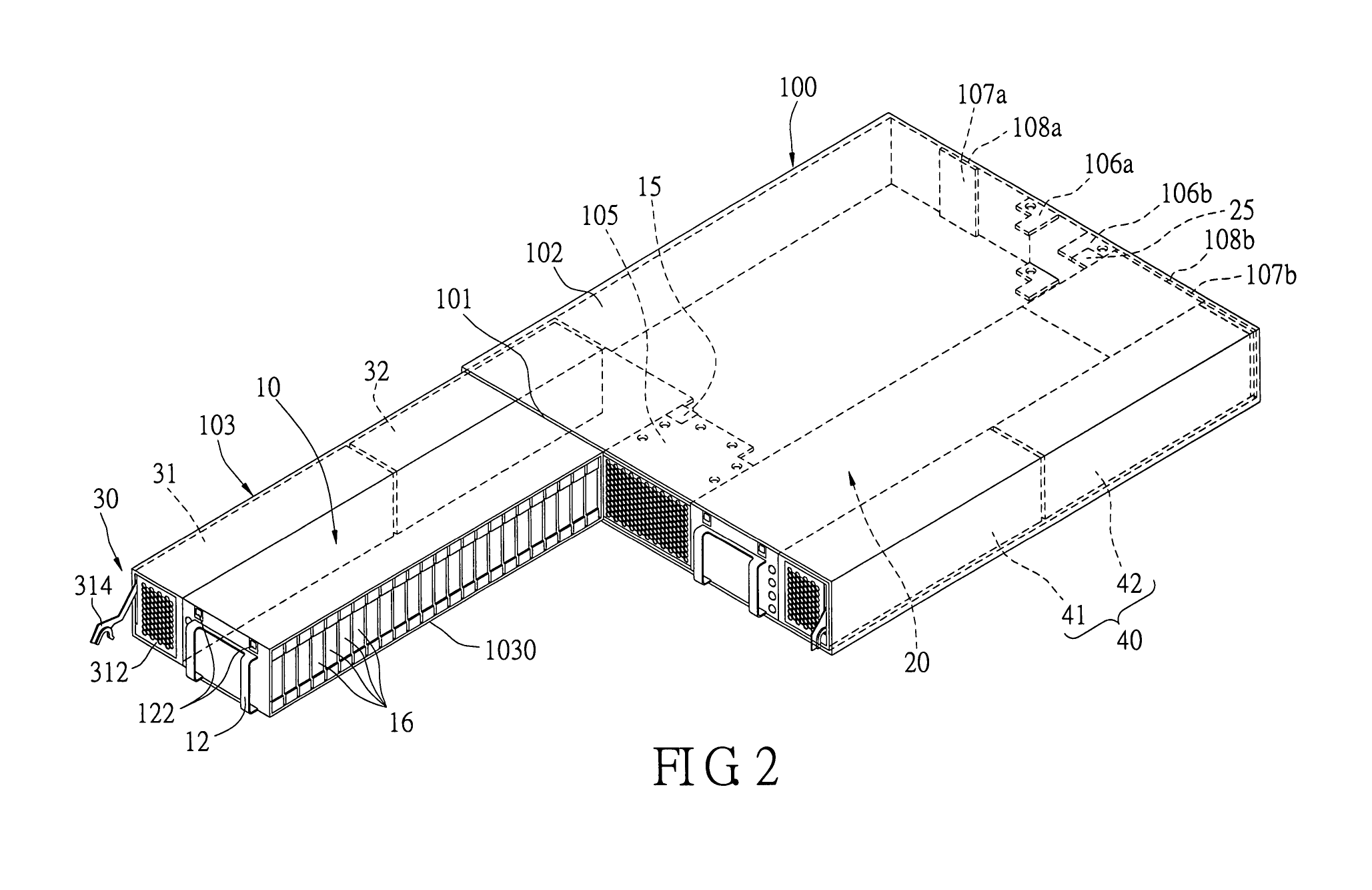

Reference is made to FIGS. 1 and 2, which are perspective views of a high-density disk array device according to the present invention. The present invention provides a high-density disk array device, which includes a casing 100, a pair of disk modules 10 and 20, and a pair of fan modules 30 and 40. The casing 100 is a rectangular hollow metal shell, and forms a entry 101 at it front surface. The casing 100 has a pair of sub-casings 103, 104. Each of the sub-casings 103, 104 accommodates one disk module and one fan module, respectively.

As shown in FIG. 2, the pair of sub-casings 103, 104 can be drawn outwardly from the entry 101 of the casing 100, so that the disk modules 10, 20 and the pair of fan modules 30, 40 can be drawn outside. The pair of disk modules 10, 20 can accommodate a plurality of removable hard disks 16,26 (hard disks 26 of the disk module 20 not shown in FIG. 2). The pair of sub-casings 103, 104 of the high-density disk array device respectively have a handle 12, 22 on a front surface thereof, and at least one lock 122, 222 on a front surface of the pair of sub-casings 103,104 to lock the casing 100. In this embodiment, the locks 122, 222 are mounted on the handles 12, 22.

For describing hereafter conveniently, the pair of disk modules 10, 20 are called first disk module 10 and second disk module 20. The first disk module 10 has at least one power module 17 and at least one input/output module 18 disposed at its rear end. The power module 17 and the input/output module 18 are electrically connecting with the hard disks 16 for supplying electrical power and inputting/outputting data, respectively.

The first disk module 10 and the second disk module 20 are separate and separated by a central passageway 50. The casing 100 has a front-central ventilating panel 52 and a rear-central ventilating panel 54 that are disposed at a front end and a rear end of the central passageway 50, respectively. Each of the sub-casings 103,104 forms a disk-drawing entry 1030,1040 (1040 is not shown) toward the central passageway 50 for drawing out the hard disks of the first disk module 10 and the second disk module 20.

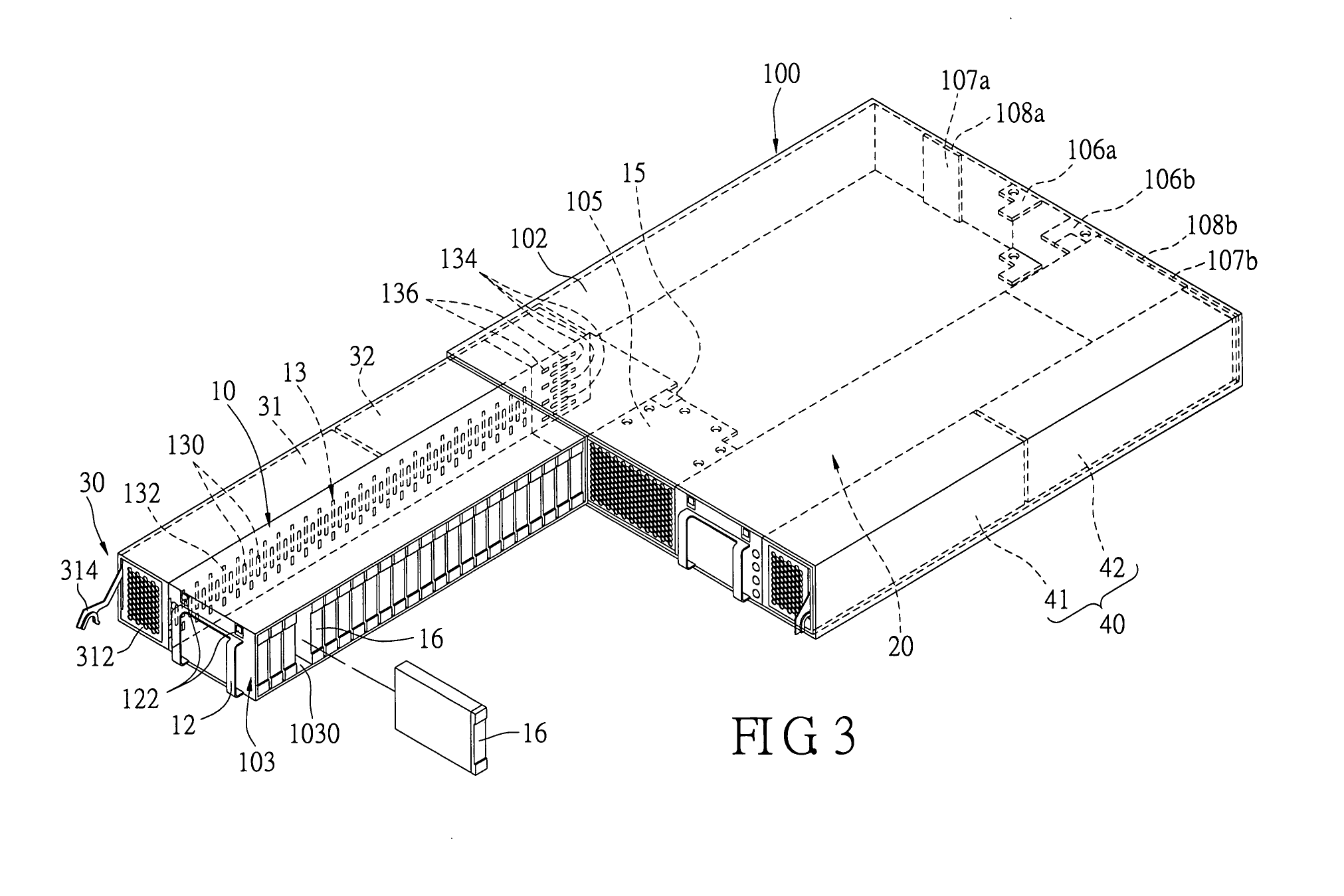

As shown in FIG. 3, the sub-casing 103 is drawn outside from the casing 100. After the first disk module 10 has been drawn out following the sub-casings 103, the hard disks 16 can be drawn from the disk-drawing entry 1030 along a direction perpendicular to the central passageway 50. In this embodiment, the hard disks 16 of the pair of disk modules 10 are arranged therein in an erect way. The hard disks 16 are arranged abreast with a gap between each other. These gaps allow the heat-dissipated airflows to flow. However, the hard disks 16 also could be received horizontally in the pair of disk modules 10 in an overlapped way.

The disk module 10 has a circuit board 13 (the circuit board 23 of the disk module 20 not shown) adjacent to an outer side. The circuit boards 13 has a plurality of heat-dissipating holes 130 formed between the hard disks 16, and a plurality of electrical connectors 132 for electrically connecting to the hard disks 16. Besides, the circuit boards 13 further has a plurality of lateral heat-dissipating holes 134 between the power module 17 and the input/output module 18 and a plurality of electrical connectors 136 for electrically connecting to the power modules 17 and the input/output modules 18.

Reference is made to FIG. 1 and FIG. 2. There is another characteristic in the present invention that providing the disk modules 10, 20 good protection measures. Each of the sub-casings 103,104 has a stopping block 15, 25 that is protruded toward the central passageway 50. The casing 100 has at least one front-positioning block 105 and at least one pair of rear-positioning blocks 106a, 106b respectively located on the moving path of the stopping blocks 15, 25. Such structure can therefore provide the functions of stopping and positioning for the sub-casings 103, 104 when drawing out or pushing in the sub-casings 103, 104. The casing 100 has a top wall 102 and a bottom wall (not labeled) that can be mounted with the front-positioning block and the rear-positioning block. The front-positioning block can be separated like the rear-positioning block. Also the rear-positioning block can be unitary like the front-positioning.

In this embodiment, the front-positioning block 105 forms two cutouts at its two sides for stopping the stopping block 15, 25 and makes the sub-casing 103,104 to stop at a drawing-out position. The pair of rear-positioning blocks 106a, 106b are L-shaped for stopping the stopping blocks 15, 25 and make the sub-casing 103,104 to stop at a pushing-in position.

In this embodiment, the casing 100 has a pair of rear fenders 108a, 108b at its rear end. As shown in FIG. 2, a crash cushion 107a is disposed on the inner side of the rear end of the casing 100, i.e. on the rear fender 108a (a crash cushion 107b on the rear fender 108b is not shown). The crash cushion 107a is used to absorb the impact when the sub-casing 103 contacts with the casing 100. It provides a protective function when the sub-casing 103 is pushed into the casing 100.

Through the aforementioned structure, the high-density disk array device of the present invention can accommodate many hard disks in a high-density arrangement with good heat-dissipating effectiveness. According to the standard of 2U rack-mount server defined by the EIA (Electronic Industries Association) for disk array device, the first disk module 10 and second disk module 20 of the present invention each can accommodate 24 standard enterprise hard disks of 2.5 inch high and 15 mm thickness. Therefore, if the present invention is applied to the disk array device of 2U standard size, it can accommodate 48 standard enterprise hard disks of 2.5 inch and 15 mm thickness. In other words, it totally can accommodate 1008 standard enterprise hard disks of 2.5 inch and 15 mm thickness in one standard cabinet of 42U rack-mount server. ((42U/2U)×48=1008)

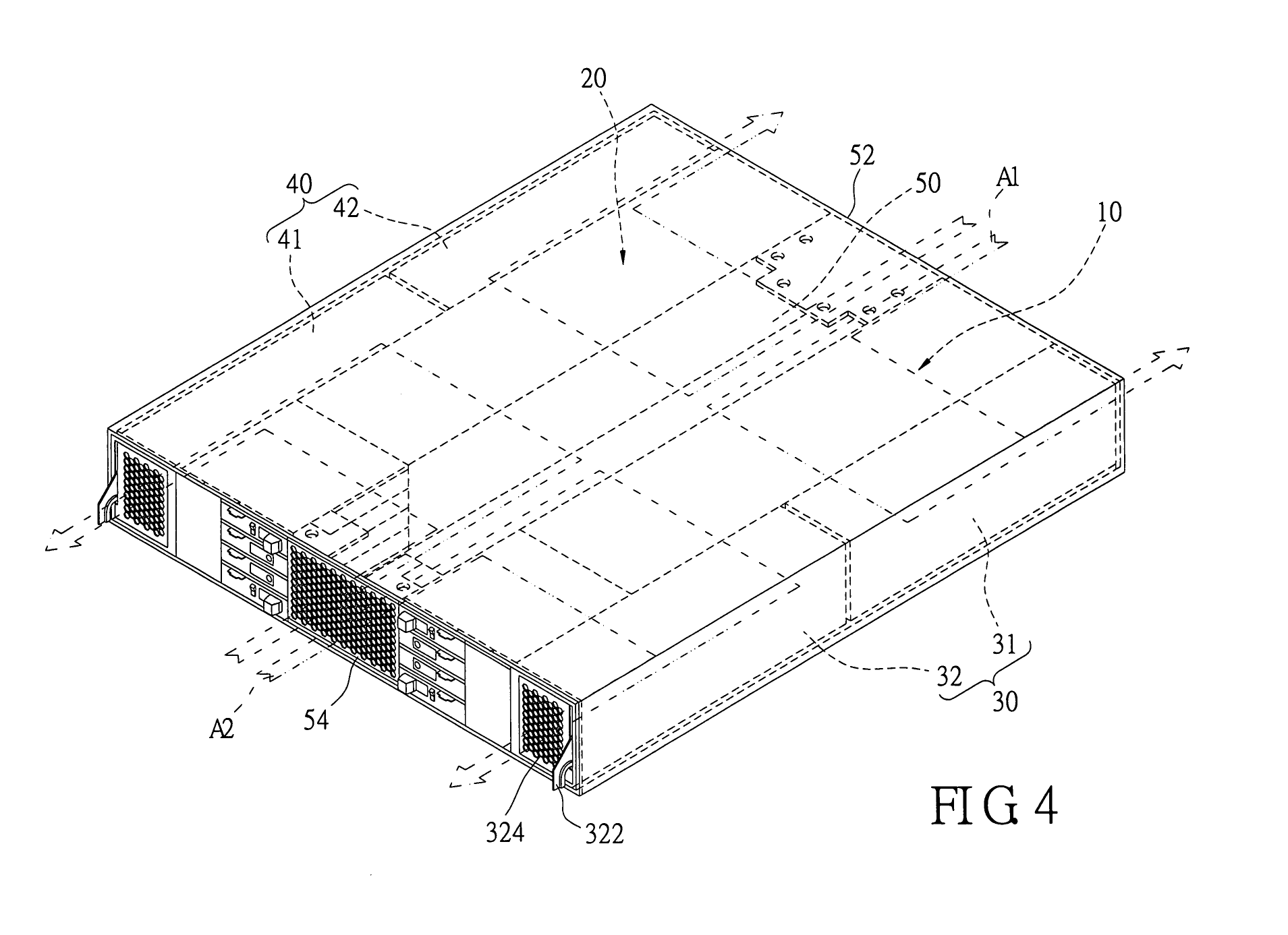

The heat-dissipating system of the high-density disk array device of the present invention is described hereafter. Reference is made to FIGS. 3 and 4. The pair of fan modules 30, 40 of the present invention are received in the casing 100 and adjacent to the outer side of the pair of disk modules 10, 20 correspondingly. In this embodiment, the pair of fan modules 30, 40 have the same mechanism and include a front fan module 31, 41 and a rear fan module 32, 42. To describe the heat-dissipating system of the present invention in viewpoint of the fan module 30, the front fan module 31 and the rear fan module 32 respectively have a ventilating panel 312, 322 for allowing the airflow flowing and a locking arm 314, 324 for locking to the sub-casing 103.

Reference is made to FIG. 4, which is a perspective view of a high-density disk array device with heat-dissipating airflow according to the present invention. The high-density disk array device of the present invention has good airflow paths for dissipating heat from the hard disks. The front fan module 31 takes in air from the front end of the central passageway 50 and forms a front airflow A1. The rear fan module 32 takes in air from the rear end of the central passageway 50 and forms a rear airflow A2. The front airflow A1 and the rear airflow A2 pass through the disk module 10 and are inhaled by fans (not shown) into the front fan module 31 and the rear fan module 32, and then are exhausted through the front end ventilating panel 312 of the front fan module 31 and the rear end ventilating panel 322 of the rear fan module 32. In other words, the pair of fan modules 30, 40 of the present invention can take in air from the front end and the rear end of the central passageway 50. The area through that the airflow flowing is larger, and the central passageway 50 provides a good air-inhaling path.

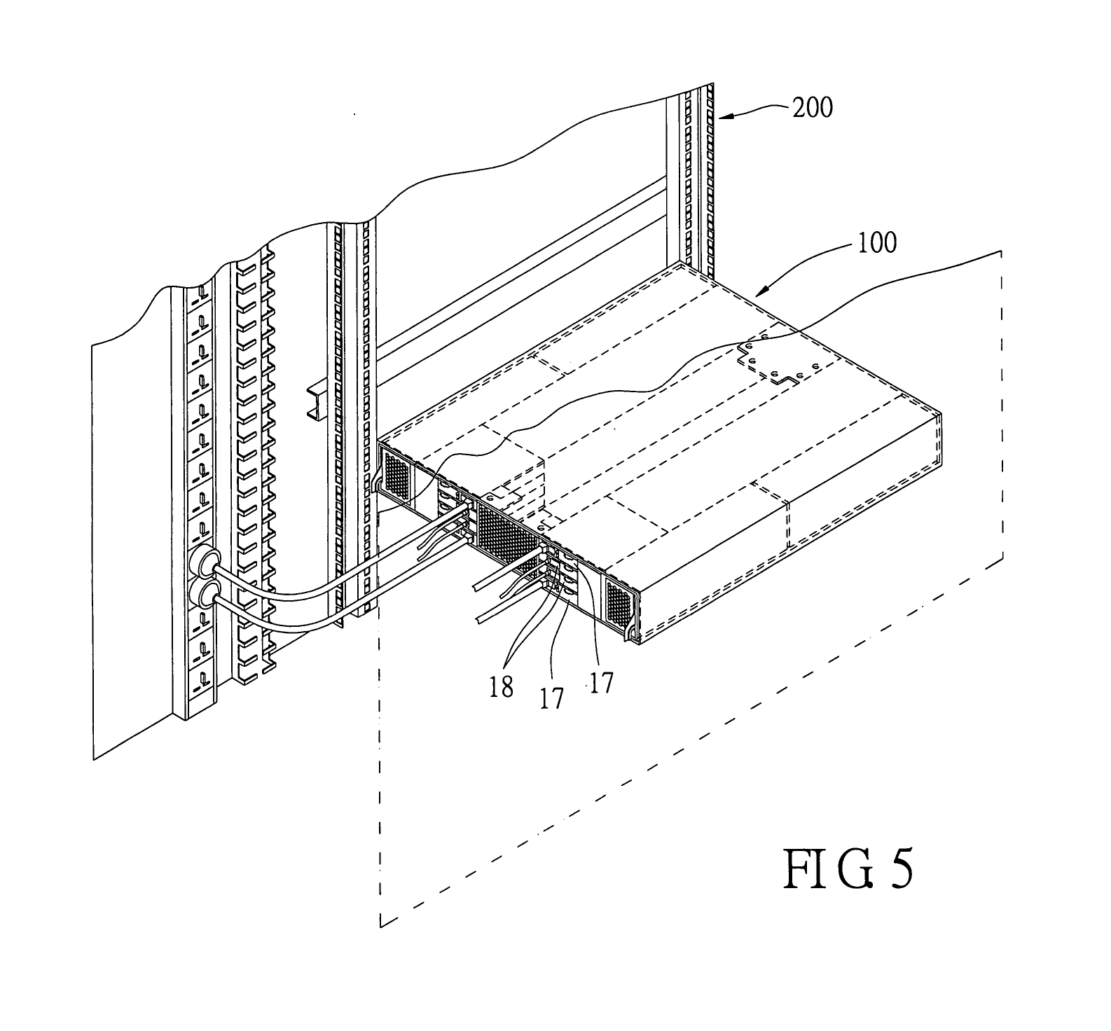

Reference is made to FIG. 5, which is a perspective view of the high-density disk array device being assembled in a cabinet according to the present invention. The high-density disk array device 100 is assembled in a cabinet 200. The disk module of one side has two power modules 17 and two input/output modules 18 that are disposed at its rear end and connected with cables.

As described above, the present invention has the following advantages:

1. The high-density disk array device of the present invention can accommodate many hard disks in a high-density way via the aforementioned characteristic structure, so that it can increase the capacity of IOPS (I/O operations per second) per volume of the disk array device.

2. The high-density disk array device of the present invention furthermore provides good heat-dissipating effectiveness in the high-density arrangement, which can ensure the operation stability of the disk array device.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A high-density disk array device, comprising
a casing, has a entry formed at a front surface thereof; and
a pair of disk modules, received in said casing and is drawable outwardly from said entry of said casing, wherein each of said disk modules has a plurality of hard disks received therein in a drawable way, at least one power module, and at least one input/output module, said power module and said input/output module adjacent to a rear surface of said casing and electrically connecting to said hard disks; wherein
a central passageway formed between said pair of disk modules, when said disk modules is drawn outside from said casing, said hard disks are drawable along a direction perpendicular to said central passageway.

2. The high-density disk array device as in claim 1, wherein said casing has a front-central ventilating panel and a rear-central ventilating panel respectively disposed at a front end and a rear end of said central passageway.

3. The high-density disk array device as in claim 1, further comprising a pair of fan modules received in said casing and adjacent to an outer side of said pair of disk modules correspondingly.

4. The high-density disk array device as in claim 3, wherein each of said fan modules has a front fan module, and a rear fan module.

5. The high-density disk array device as in claim 4, wherein said front fan module and said rear fan module respectively has a locking arm.

6. The high-density disk array device as in claim 4, wherein said front fan module takes in air from a front end of said central passageway and forms a front airflow, said rear fan module takes in air from a rear end of said central passageway and forms a rear airflow, said front airflow and said rear airflow pass through said pair of disk modules and are exhausted via the front end of said front fan module and the rear end of said rear fan module.

7. The high-density disk array device as in claim 3, further comprising a pair of sub-casings received in said casing and disposed at two sides of said central passageway, each of said sub-casings has a said disk module and a said fan module.

8. The high-density disk array device as in claim 7, wherein each said sub-casings has a handle mounted on a front surface thereof and at least one lock on a front surface thereof to lock said casing.

9. The high-density disk array device as in claim 7, wherein said pair of sub-casings respectively has a stopping block protruded toward said central passageway, said casing has at least one a front-positioning block and at least one rear-positioning block on a moving paths of each of said stopping block correspondingly.

10. The high-density disk array device as in claim 7, further comprising a crash cushion disposed at an inner side of the rear end of said casing to absorb an impact when the sub-casing contacts with the casing.

11. The high-density disk array device as in claim 1, wherein said hard disks of said pair of disk modules are arranged in an erect way, said hard disks are arranged abreast with a gap between each other.

12. The high-density disk array device as in claim 11, wherein each of said disk modules has a circuit board adjacent to an outer side thereof, each of said circuit boards has a plurality of electrical connectors for electrically connecting to said hard disks, and a plurality of heat-dissipating holes formed between said hard disks.

13. The high-density disk array device as in claim 12, wherein said circuit board extends to a rear end of said casing and electrically connecting to said power module and said input/output module.

14. The high-density disk array device as in claim 1, wherein said hard disks are received horizontally in said disk modules in an overlapped way.

15. The high-density disk array device as in claim 1, wherein said hard disks of said disk modules are 2.5 inch and 15 mm thickness, and each of said disk modules has 24 hard disks.
